(19) United States
(12) Patent Application Publication
(10) Pub. No.: US 2026/0163348 A1
(43) Pub. Date: Jun. 11, 2026

(54) CABLE HOLDER COMPRISING TWO ROTARY DISKS AND ELECTRICAL INSTALLATION INCLUDING AT LEAST ONE SUCH CABLE HOLDER

(71) Applicant: Airbus Operations SAS, TOULOUSE (FR)

(72) Inventors: Gérard MILLET, TOULOUSE (FR); Vincent DELPY, TOULOUSE (FR)

(21) Appl. No.: 19/181,863

(22) Filed: Apr. 17, 2025

(30) Foreign Application Priority Data
Apr. 25, 2024 (FR) FR2404257

(51) Int. Cl. H02G 3/32

(52) U.S. Cl. CPC H02G 3/32

(57) ABSTRACT

A cable holder including a first disk which has first seats each configured to receive a first cable, at least one second disk which can pivot relative to the first disk between first and second angular positions, this second disk being configured to allow the first cables to be inserted into the first seats in the first angular position and to prevent the first cables from coming out of the first seats in the second angular position. An electrical installation including at least one such cable holder and an aircraft including at least one such electrical installation are also provided.

### CROSS-REFERENCES TO RELATED APPLICATIONS

This application claims the benefit of French Patent Application Number 2404257 filed on Apr. 25, 2024, the entire disclosures of which are incorporated herein by way of reference.

### FIELD OF THE INVENTION

The present application relates to a cable holder comprising two rotating disks, an electrical installation including at least one such cable holder, and an aircraft comprising such an electrical installation.

### BACKGROUND OF THE INVENTION

According to an embodiment visible in FIG. 1, an aircraft 10 comprises a fuselage 12, wings 14, main propulsion assemblies 16, and an auxiliary power unit 18.

The aircraft 10 comprises an electrical installation 20 which includes at least one electrical master box 20.1 and at least one electrical route 20.2 connecting the electrical master box 20.1 to different electrical sources 20.3 such as the main propulsion assemblies 16, the auxiliary power unit 18, or an emergency electrical source, for example.

As illustrated in FIG. 2, each electrical route 20.2 comprises several cables 22.1, 22.2, several cable holders 24 distributed along the electrical route 20.2 and each designed to keep the electrical cables 22.1, 22.2 spaced apart from one another, as well as, for each cable holder 24, a clamping collar 26 designed to hold the cables 22.1, 22.2 on the cable holder 24 and connect the latter to a structure 28.

According to an embodiment of the prior art visible in FIG. 3, the electrical route 20.2 comprises six first cables 22.1 each designed to convey an electrical power current, as well as a second cable 22.2 designed to convey an electrical excitation current. Each cable holder 24 comprises:
a disk,
several peripheral notches 30, one for each first cable 22.1, positioned at the peripheral edge face of the disk,
peripheral tabs 32, one for each first cable 22.1, connected to the peripheral edge face of the disk and designed to hold the first cables 22.1 in their peripheral notches 30,
a central orifice 34 traversing the disk,
two central tabs 36 positioned near to the central hole 34 and designed to hold therebetween the second cable 22.2.

Each peripheral tab 32 comprises a first end 32.1 connected to the peripheral edge face of the disk and a second end 32.2 spaced apart from the peripheral edge face of the disk by a distance less than the diameter of a first cable 22.1.

Although this embodiment of the prior art makes it possible to keep the first and second cables 22.1, 22.2 spaced apart from each other, the cable holder 24 is not entirely satisfactory for the following reasons.

A first reason is that the clamping collar 26 must be correctly oriented with respect to the orientation of the peripheral tabs 32. Otherwise, as shown in FIG. 3 in dotted lines, one end 26.1 of the metal strip forming the clamping collar 26 may become inserted between the second end 32.2 of a peripheral tab 32 and the peripheral edge face of the disk and come into contact with the first cable 22.1 held by the peripheral tab 32.

A second reason is that it is difficult to insert each first cable 22.1 into its notch 30 because the distance separating the second end 32.2 of each peripheral tab 32 and the peripheral edge face of the disk is smaller than the diameter of the first cables 22.1. Consequently, it is necessary to provide a tool in the form of a card to facilitate the insertion of each first cable between the second end 32.2 of a tab 32 and the peripheral edge face of the disk.

### SUMMARY OF THE INVENTION

The present invention is intended to overcome some or all of the drawbacks in the prior art.

For this purpose, the invention relates to a cable holder designed to hold first cables keeping them spaced apart from one another, the cable holder including a first disk which has a first peripheral edge face and first seats which open into the first peripheral edge face and are each designed to receive a first cable.

According to the invention, the cable holder comprises at least one second disk and a pivoting connection connecting the first and second disks and allowing the second disk to pivot relative to the first disk between first and second angular positions, the second disk being designed to allow the first cables to be inserted into the first seats in the first angular position and to prevent the first cables from coming out of the first seats in the second angular position. Additionally, the cable holder comprises at least one locking system designed to be in a locked state in which the locking system holds the first and second disks in the second angular position and in an unlocked state in which the locking system allows the second disk to pivot relative to the first disk between the first and second angular positions. This locking system comprises a first shape integral with the second disk and a second shape integral with the first disk, the first and second shapes being designed to cooperate in the locked state and to be separated in the unlocked state, the first shape being a hook located on at least one tab, the second shape being a notch located on the first disk and designed to hold the hook.

When in the open state, this cable holder facilitates insertion of the first cables into the first seats and ensures that the first cables are effectively held when in the closed state. According to another advantage, when in the closed state, it allows the first cables to be separated from a clamping collar provided to connect the cable holder to a structure.

According to another feature, the second disk comprises a second peripheral edge face and, for each first seat, a second seat opening into the second peripheral edge face. Additionally, the cable holder comprises, for each second seat, a tab connected to the second disk, partially blocking the second seat to allow a first cable to enter the first seat in the first angular position and to at least partially close the first seat in the second angular position.

According to another feature, each tab has a first end integral with the second disk and a second end spaced apart from the first disk in the first angular position and contiguous with the first disk in the second angular position.

According to another feature, each first seat is delimited by a first bottom as well as by first right-and left-hand lateral edge faces connecting the first bottom and the first peripheral edge face. Additionally, each second seat is delimited by a second bottom as well as by second right-and left-hand lateral edge faces connecting the second bottom and the second peripheral edge face, the first right-and left-hand lateral edge faces being spaced apart from each other by a first distance substantially equal to the diameter of a first cable, the second right-and left-hand lateral edge faces being spaced further apart than the first right-and left-hand side edge faces.

According to another feature, the second right-and left-hand lateral edge faces of each second seat are designed so that the first and second right-hand lateral edge faces are superposed in the first angular position and the first and second left-hand lateral edge faces are superposed in the second angular position.

According to another feature, the first disk comprises at least one elastically deformable bead, in at least one first seat, designed to allow a first cable to be inserted into the first seat and held in the first seat.

According to another feature, at least one first seat comprises a first extension intended to receive a second cable. Additionally, each second seat, associated with a first seat provided with a first extension, comprises a second extension designed to receive a second cable; the cable holder comprising, for each second extension, a pin integral with the second disk and partially blocking the second extension so as to allow a second cable to enter the first extension in the first angular position and to at least partially close the first extension in the second angular position.

According to another feature, the first disk comprises at least one elastically deformable bead in at least one first extension, designed to allow a second cable to be inserted into the first extension and held in the first extension.

According to another feature, the first disk comprises a lateral extension, level with the second peripheral edge face of the second disk, on which the notch is positioned.

According to another feature, the first disk comprises a loop, positioned on the lateral extension and designed to guide the tab and keep the hook engaged with the notch.

According to another feature, the locking system comprises at least one flexible clamping collar which traverses and connects the first and second disks.

The invention also relates to an electrical installation comprising at least one cable holder according to one of the preceding features and to an aircraft including at least one such electrical installation.

### BRIEF DESCRIPTION OF THE DRAWINGS

Other features and advantages will become apparent from the following description of the invention, the description being given solely by way of example, with reference to the appended drawings, in which:

FIG. 1 is a side view of an aircraft,

FIG. 2 is a perspective view of a portion of an electrical route, illustrating an embodiment of the prior art,

FIG. 3 is a front view of a cable holder, illustrating an embodiment of the prior art,

FIG. 4 is a front view of a cable holder, illustrating an embodiment of the invention in an open state,

FIG. 5 is a front view of the cable holder visible in FIG. 4, in a closed state,

FIG. 6 is a perspective view of a first disk of the cable holder visible in FIG. 4,

FIG. 7 is a perspective view of a second disk of the cable holder visible in FIG. 4,

FIG. 8 is a perspective view of a locking system for a cable holder, illustrating an embodiment of the invention,

FIG. 9 is a perspective view of a first part of the locking system visible in FIG. 8,

FIG. 10 is a perspective view of a part of a cable holder fitted with a locking system, illustrating an embodiment of the invention,

FIG. 11 is a front view of a cable holder, illustrating another embodiment of the invention.

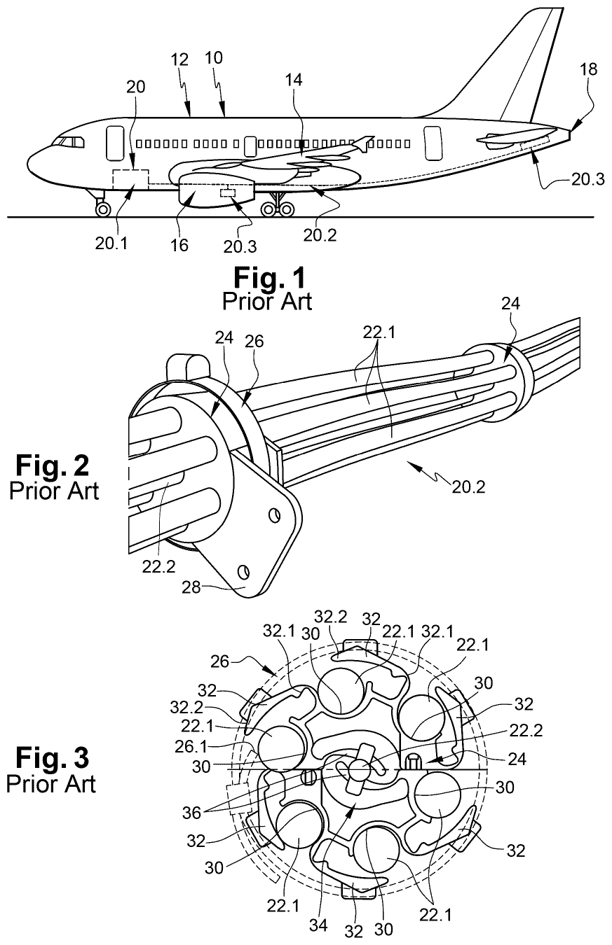

### DETAILED DESCRIPTION OF THE PREFERRED EMBODIMENTS

An aircraft comprises at least one electrical installation including at least one cable route having at least two first cables 40 and at least one cable holder 42 designed to hold the first cables 40 and to keep them apart.

According to one embodiment, the cable route comprises first cables 40 each designed to convey an electrical power current, as well as at least one second cable 40′ designed to convey an electrical excitation current. The first cable 40 has a first diameter greater than the second diameter of the second cable 40′.

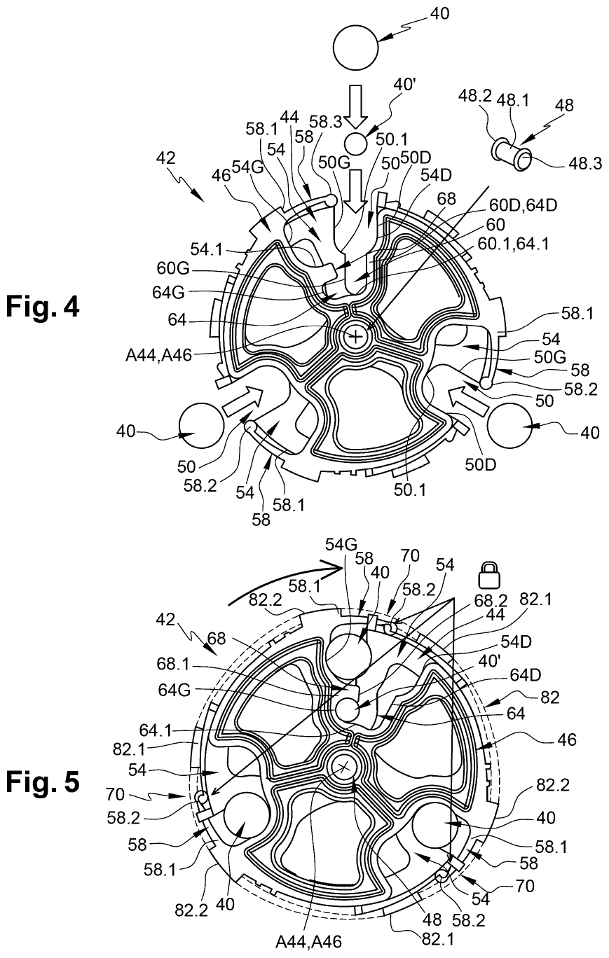

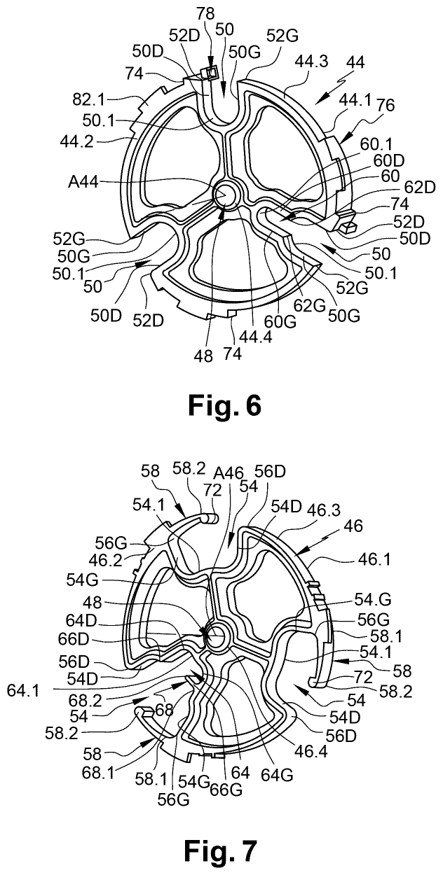

As illustrated in FIGS. 4 to 7, each cable holder 42 comprises at least first and second disks 44, 46 which have inner faces 44.1, 46.1 oriented towards each other, outer faces 44.2, 46.2 opposite the inner faces 44.1, 46.1, first and second peripheral edge faces 44.3, 46.3 connecting, for each of the first and second disks 44, 46, the inner and outer faces 44.1, 44.2, 46.1, 46.2 as well as the first and second coincident axes A44, A46. In operation, the inner faces 44.1, 46.1 are pressed against each other and the second disk 46 is designed to pivot relative to the first disk 44 about the second axis A46. According to one embodiment, each of the first and second disks 44, 46 is perforated to limit its mass.

According to one embodiment, the cable holder 42 comprises a pivot shaft 48. Additionally, each of the first and second disks 44, 46 comprises a first or second cylindrical through-hole 44.4, 46.4 coaxial with the first or second axis A44, A46, designed to receive the pivot shaft 48. According to an arrangement visible in FIG. 4, the pivot shaft 48 comprises a cylindrical body 48.1 which has a diameter substantially equal to the diameter of the first and second through-holes 44.4, 44.6 so as to form a pivoting connection connecting each of the first and second disks 44, 46 and the pivot shaft 48. Additionally, the pivot shaft 48 comprises first and second heads 48.2, 48.3, positioned at each end of the cylindrical body 48.1, which have cross-sections larger than the cross-section of the cylindrical body 48.1 so as to immobilize the first and second disks 44, 46 in translation in a direction parallel to the first and second axes A44, A46. According to one embodiment, the first and second heads 48.2, 48.3 are spaced apart by a distance substantially equal to the sum of the thicknesses of the first and second disks 44, 46. Other solutions for obtaining a pivoting connection between the first and second disks 44, 46 which allows the second disk 46 to pivot relative to the first disk 44 are conceivable.

For each first cable 40, the first disk 44 comprises a first seat 50 opening into the first peripheral edge face 44.3 and designed to receive the first cable 40. According to one embodiment, the first seat 50 has a U-shaped cross-section, which extends from the inner face 44.1 to the outer face 44.2, delimited by a first bottom 50.1 distant from the first peripheral edge face 44.3 of the first disk 44 and by first right-and left-hand lateral edge faces 50D, 50G which are substantially parallel to each other and connect the first bottom 50.1 and the first peripheral edge face 44.3 of the first disk 44. The first bottom 50.1 describes a circular arc which has a diameter substantially equal to the diameter of the first cable 40. The first right-and left-hand lateral edge faces 50D, 50G are spaced apart by a first distance substantially equal to the diameter of the first cable 40. The first seat 50 has a depth (the greatest distance between the first bottom 50.1 and the first peripheral edge face 44.3 of the first disk 44) greater than or equal to the diameter of the first cable 40. Each first seat 50 has first right-and left-hand edges 52D, 52G at the first peripheral edge face 44.3 of the first disk 44, extending the first right-and left-hand lateral edge faces 50D, 50G, respectively.

According to one arrangement, the first disk 44 comprises as many first seats 50 as there are first cables 40 in the cable route. According to one arrangement, the first seats 50 are regularly distributed along the entire circumference of the first disk 44.

The second disk 46 is designed to be in a first angular position, visible in FIG. 4 and corresponding to an open state, in which the second disk 46 allows each first cable 40 to be inserted into a first seat 50, and a second angular position, visible in FIG. 5 and corresponding to a closed state, in which the second disk 46 prevents the first cables 40 from coming out of the first seats 50 of the first disk 44.

For this purpose, the second disk 46 comprises, for each first seat 50, a second seat 54 designed to allow a first cable 40 to enter the first seat 50 in the first angular position visible in FIG. 4 and to prevent the first cable 40, positioned in the first seat 50, from coming out of the first seat 50 in the second angular position visible in FIG. 5.

According to one embodiment, each second seat 54 opens into the second peripheral edge face 46.3, extends from the inner face 46.1 to the outer face 46.2, and comprises a second bottom 54.1 as well as second right-and left-hand lateral edge faces 54D, 54G connecting the second bottom 54.1 and the second peripheral edge face 46.3 of the second disk 46.

The second right-and left-hand lateral edge faces 54D, 54G are spaced further apart than the first right-and left-hand lateral edge faces 50D, 50G and designed so that the first and second right-hand lateral edge faces 50D, 54D are superposed in the first angular position, as shown in FIG. 4, and the first and second left-hand lateral edge faces 50G, 54G are superposed in the second angular position, as illustrated in FIG. 5. Each second seat 54 has second right-and left-hand edges 56D, 56G at the second peripheral edge face 46.3 of the second disk 46, extending the second right-and left-hand lateral edge faces 54D, 54G, respectively.

The cable holder 42 comprises, for each second seat 54, a tab 58, extending the second peripheral edge face 46.3, which has a first end 58.1 connected to the second left-hand lateral edge face 54G, and more precisely to the second left-hand edge 56G of the second seat 54, as well as a second end 58.2 spaced apart from the second right-hand lateral edge face 54D, and more precisely from the second right-hand edge 56D of the second seat 54, to allow a first cable 40 to pass through. The second end 58.2 of the tab 58 is spaced apart from the second right-hand edge 56D of the second seat 54 by a distance substantially equal to or greater than the diameter of the first cable 40. Regardless of the embodiment, the cable holder 42 comprises, for each second seat 54, a tab 58 connected to the second disk 46, partially blocking the second seat 54 to allow a first cable 40 to enter the first seat 50 in the first angular position and to at least partially close the first seat 50 in the second angular position.

For each pair of first and second seats 50, 54, the second end 58.2 of the tab 58 is spaced apart from the first disk 44 in the first angular position, corresponding to the open state, and contiguous with the first disk 44 in the second angular position, corresponding to the closed state.

According to one embodiment, at least one first seat 50 comprises a first extension 60, intended to receive a second cable 40′, which extends from the inner face 44.1 to the outer face 44.2 and has a U-shaped cross-section including a third bottom 60.1 distant from the first bottom 50.1 of the first seat 50 as well as third right-and left-hand lateral edge faces 60D and 60G which are substantially parallel to each other and connect the third bottom 60.1 and the first bottom 50.1 of the first seat 50. The third bottom 60.1 describes a circular arc which has a diameter substantially equal to the diameter of the second cable 40′. The third right-and left-hand lateral edge faces 60D, 60G are spaced apart by a third distance substantially equal to the diameter of the second cable 40′, less than the diameter of the first cable 40. The first extension 60 has a depth (the greatest distance between the third bottom 60.1 and the first bottom 50.1 of the first seat 50) greater than the diameter of the second cable 40′ so that a first cable 40 in contact with the first bottom 50.1 of the first seat 50 is spaced apart from the second cable 40′ in contact with the third bottom 60.1 of the first extension 60. The latter comprises third right-and left-hand edges 62D, 62G at the first bottom 50.1 of the first seat 50, extending the third right-and left-hand lateral edge faces 60D, 60G, respectively.

Additionally, each second seat 54, associated with a first seat 50 provided with a first extension 60 intended to receive a second cable 40′, comprises a second extension 64, designed to receive a second cable 40′, which extends from the inner face 46.1 to the outer face 46.2 and has a cross-section delimited by a fourth bottom 64.1 distant from the second bottom 54.1 of the second seat 54 as well as by fourth right-and left-hand lateral edge faces 64D and 64G, which are substantially parallel to each other and connect the fourth bottom 64.1 and the second bottom 54.1 of the second seat 54.

The fourth right-and left-hand lateral edge faces 64D, 64G of the second extension 64 are spaced further apart than the third right-and left-hand lateral edge faces 60D, 60G of the first extension 60 and designed so that the third and fourth right-hand lateral edge faces 60D, 64D are superposed in the first angular position, as illustrated in FIG. 4, and the third and fourth left-hand lateral edge faces 60G, 64G are superposed in the second angular position, as illustrated in FIG. 5. Each second extension 64 has fourth right-and left-hand edges 66D, 66G at the second bottom 54.1 of the second seat 54, extending the fourth right-and left-hand lateral edge faces 64D, 64G of the second extension 64, respectively.

According to one embodiment, the cable holder 42 comprises, for each second extension 64, a pin 68 integral with the second disk 46 and extending the second bottom 54.1 of the second seat 54, which has a first end 68.1 connected to the fourth left-hand edge 66G of the second extension 64 and a second end 68.2 spaced apart from the fourth right-hand edge 56D of the second extension 64 to allow a second cable 40′ to pass through. The second end 68.2 of the pin 68 is spaced apart from the fourth right-hand edge 66D of the second extension 64 by a distance substantially equal to or very slightly greater than the diameter of a second cable 40′ and less than the diameter of a first cable 40. Thus, as illustrated in FIGS. 4 and 5, each pin 68 partially blocks the second extension 64 so as to allow a second cable 40′ to enter the first extension 60 in the first angular position corresponding to the open state and to at least partially close the first extension 60 in the second angular position corresponding to the closed state. In this state, the pin 68 separates the first and second cables 40, 40′.

In operation, the second cable 40′ is received in the first and second extensions 60, 64, in contact with the third and fourth bottoms 60.1, 64.1. Each first cable 40 is received in a pair of first and second seats 50, 54, in contact with the first and second bottoms 50.1, 54.1. The pin 68 is used to keep the first and second cables 40, 40′ apart.

According to one embodiment, the cable holder 42 comprises at least one locking system 70 designed to be in a locked state in which the locking system 70 holds the first and second disks 44, 46 in the second angular position corresponding to the closed state and in an unlocked state in which the locking system 70 allows the second disk 46 to pivot relative to the first disk 44 between the first and second angular positions.

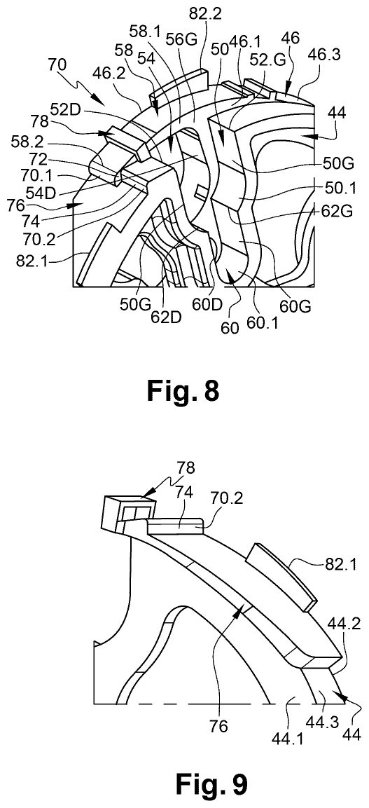

According to an embodiment visible in FIGS. 8 and 9, the locking system 70 comprises a first shape 70.1 integral with at least one tab 58 connected to the second disk 46 and a second shape 70.2 integral with the first disk 44, the first and second shapes 70.1, 70.2 being designed to cooperate in the locked state and to be separated in the unlocked state. According to one arrangement, the first shape 70.1 is a hook 72 located on the second end 58.2 of at least one tab 58. The second shape 70.2 is a notch 74 located on the first disk 44 and designed to hold the hook 72. The first disk 44 comprises a lateral extension 76, level with the second peripheral edge face 46.3 of the second disk 46, on which the notch 74 is positioned. Additionally, the first disk 44 comprises a loop 78, positioned on the lateral extension 76, and designed to guide the tab 58 and keep the hook 72 engaged with the notch 74.

According to one embodiment, the cable holder 42 comprises as many locking systems 70 as there are tabs 58. Thus, each tab 58 has a hook 72 at its second end 58.2. Additionally, for each tab 58, the first disk 44 comprises a lateral extension 76 which has a notch 74 and a loop 78.

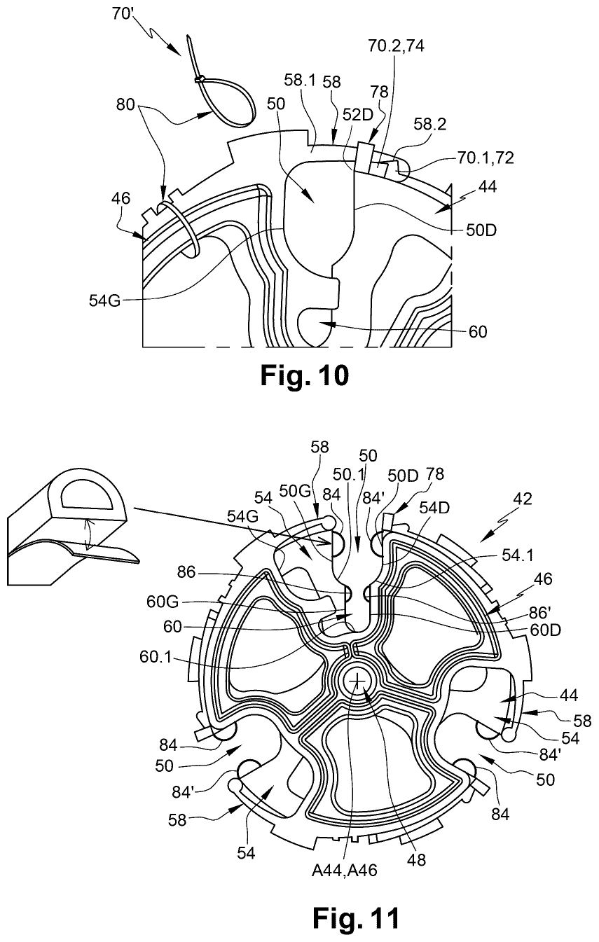

Of course, the invention is not limited to this embodiment of the locking system 70. According to another embodiment visible in FIG. 10, the locking system 70′ comprises at least one flexible clamping collar 80 which traverses and connects the first and second disks 44, 46. In a variant, a single cable holder 42 may comprise at least one locking system of a first type including first and second cooperating shapes 70.1, 70.2, as illustrated in FIGS. 8 and 9, and at least one locking system 70′ of a second type including a flexible clamping collar 80, as illustrated in FIG. 10.

According to an embodiment visible in FIG. 5, the cable holder 42 may comprise a clamping collar 82 for connecting it to a structure. In this case, the first and second disks 44, 46 comprise lateral guides 82.1, 82.2 for holding the clamping collar on the first and second peripheral edge faces 44.3, 46.3 of the first and second disks 44, 46.

According to an embodiment visible in FIG. 11, the first disk 44 comprises at least one elastically deformable bead 84, in at least one first seat 50, designed to allow a first cable 40 to be inserted into the first seat 50 and held in the first seat 50, including when the second disk 46 is in the open state. According to one embodiment, the first disk 44 comprises, in each first seat 50, two elastically deformable beads 84, 84′ positioned facing each other, on the first right-and left-hand lateral edge faces 50D, 50G, respectively.

According to one embodiment, the first disk 44 comprises at least one elastically deformable bead 86 in at least one first extension 60, designed to allow a second cable 40′ to be inserted into the first extension 60 and held in the first extension 60, including when the second disk 46 is in the open state. According to one embodiment, the first disk 44 comprises two elastically deformable beads 86, 86′ positioned facing each other, on the third right-and left-hand lateral edge faces 60D, 60G, respectively.

The cable holder 42 according to the invention is used to keep the first and second cables 40, 40′ spaced apart from each other. When in the open state, this cable holder 42 facilitates insertion of the first and second cables 40, 40′ into the first and second seats 50, 54 and the first and second extensions 60, 64 and ensures that the first and second cables 40, 40′ are effectively held when in the closed state. According to another advantage, when in the closed state, the tabs 58 allow the first cables to be separated from the clamping collar provided to connect the cable holder 42 to a structure.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cable holder configured to hold first cables keeping them spaced apart from one another, the cable holder comprising:
a first disk which has a first peripheral edge face and first seats which open into the first peripheral edge face and are each configured to receive a first cable,
a second disk and a pivoting connection connecting the first and second disks and allowing the second disk to pivot relative to the first disk between first and second angular positions, the second disk being configured to allow the first cables to be inserted into the first seats in the first angular position and to prevent the first cables from coming out of the first seats in the second angular position,
at least one locking system configured to be in a locked state in which the locking system holds the first and second disks in the second angular position and in an unlocked state in which the locking system allows the second disk to pivot relative to the first disk between the first and second angular positions, and
wherein the locking system comprises a first shape integral with the second disk and a second shape integral with the first disk, the first shape and second shape being configured to cooperate in the locked state and to be separated in the unlocked state, the first shape being a hook located on at least one tab, the second shape being a notch located on the first disk and configured to hold the hook.

2. The cable holder as claimed in claim 1,
wherein the second disk comprises a second peripheral edge face and, for each first seat, a second seat opening into the second peripheral edge face, and
wherein the cable holder comprises, for each second seat, a tab connected to the second disk, partially blocking the second seat to allow a first cable to enter the first seat in the first angular position and to at least partially close the first seat in the second angular position.

3. The cable holder as claimed in claim 2, wherein each tab connected to the second disk has a first end integral with the second disk and a second end spaced apart from the first disk in the first angular position and contiguous with the first disk in the second angular position.

4. The cable holder as claimed in claim 2,
wherein each first seat is delimited by a first bottom as well as by first right-and left-hand lateral edge faces connecting the first bottom and the first peripheral edge face, and
wherein each second seat is delimited by a second bottom as well as by second right-and left-hand lateral edge faces connecting the second bottom and the second peripheral edge face,
wherein the first right-and left-hand lateral edge faces are spaced apart from each other by a first distance substantially equal to a diameter of a first cable, and
wherein the second right-and left-hand lateral edge faces are spaced further apart than the first right-and left-hand side edge faces.

5. The cable holder as claimed in claim 4, wherein the second right-and left-hand lateral edge faces of each second seat are configured so that the first and second right-hand lateral edge faces are superposed in the first angular position and the first and second left-hand lateral edge faces are superposed in the second angular position.

6. The cable holder as claimed in claim 1, wherein the first disk comprises at least one elastically deformable bead, in at least one first seat, configured to allow a first cable to be inserted into the first seat and held in the first seat.

7. The cable holder as claimed in claim 2, wherein at least one first seat comprises a first extension configured to receive a second cable,
wherein each second seat, associated with the at least one first seat provided with a first extension, comprises a second extension configured to receive a second cable, and
wherein the cable holder comprises, for each second extension, a pin integral with the second disk and partially blocking the second extension so as to allow the second cable to enter the first extension in the first angular position and to at least partially close the first extension in the second angular position.

8. The cable holder as claimed in claim 7, wherein the first disk comprises at least one elastically deformable bead in at least one first extension, configured to allow the second cable to be inserted into the first extension and held in said first extension.

9. The cable holder as claimed in claim 2, wherein the first disk comprises a lateral extension, level with the second peripheral edge face of the second disk, on which the notch is positioned.

10. The cable holder as claimed in claim 9, wherein the first disk comprises a loop, positioned on the lateral extension, configured to guide the tab and keep the hook engaged with the notch.

11. The cable holder as claimed in claim 1, wherein the locking system comprises at least one flexible clamping collar which traverses and connects the first and second disks.

12. An electrical installation comprising at least one cable holder as claimed in claim 1.

13. An aircraft comprising at least one electrical installation as claimed in claim 12.
